(19) United States
(12) Patent Application Publication
(10) Pub. No.: US 2024/0004725 A1
(43) Pub. Date: Jan. 4, 2024

(54) ADAPTIVE POWER THROTTLING SYSTEM

(71) Applicants: Advanced Micro Devices, Inc., Santa Clara, CA (US); ATI Technologies ULC, Markham (CA)

(72) Inventors: Ashish Jain, Austin, TX (US); Shang Yang, Markham (CA); Arash Moghimi, Markham (CA)

(21) Appl. No.: 17/854,650

(22) Filed: Jun. 30, 2022

(51) Int. Cl. G06F 9/50

(52) U.S. Cl. CPC G06F 9/5094; G06F 9/505; G06F 9/5038

(57) ABSTRACT

Systems, apparatuses, and methods for managing power allocation in a computing system. A system management unit detects a condition indicating a change in power is indicated. Such a change may be detecting an indication that a power change is either required, possible, or requested. In response to detecting a reduction in power is indicated, the system management unit identifies currently executing tasks of the computing system and accesses sensitivity data to determine which of a number of computing units (or power domains) to select for power reduction. Based at least in part on the data, a unit is identified that is determined to have a relatively low sensitivity to power state changes under the current operating conditions. A relatively low sensitivity indicates that a change in power to the corresponding unit will not have as significant an impact on overall performance of the computing system than if another unit was selected. Power allocated for the selected unit is then decreased.

### BACKGROUND

### Description of the Related Art

During the design of a computer or other processor-based system, many design factors must be considered. A successful design may require a variety of tradeoffs between power consumption, performance, thermal output, and so on. For example, the design of a computer system with an emphasis on high performance may allow for greater power consumption and thermal output. Conversely, the design of a portable computer system that is sometimes powered by a battery may emphasize reducing power consumption at the expense of some performance. Whatever the particular design goals, a computing system typically has a given amount of power available to it during operation. This power must be allocated amongst the various components within the system—a portion is allocated to the central processing unit, another portion to the memory subsystem, a portion to a graphics processing unit, and so on. How the power is allocated amongst the system components may also change during operation.

While it is understood that power must be allocated within a system, how the power is allocated can significantly affect system performance. For example, if too much of the system power budget is allocated to the memory, then processors may not have an adequate power budget to execute pending instructions and performance of the system may suffer. Conversely, if the processors are allocated too much of the power budget and the memory subsystem not enough, then servicing of memory requests may be delayed which in turn may cause stalls within the processor(s) and decrease system performance. Further, when a power or thermal limit is reached, power allocated for one or more components of the system must be reduced. However, determining which of the components to reduce without unduly impacting system performance is difficult.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram of another implementation of a computing system.

FIG. 3 is a block diagram of a computing system including a task scheduler.

FIG. 4 is a block diagram of one implementation of a task scheduler.

FIG. 5 is a block diagram of one implementation of a system management unit.

FIG. 6 shown an example of data corresponding to sensitivity to power state changes.

FIG. 7 is a generalized flow diagram illustrating one implementation of a method for changing power states in a computing system.

FIG. 8 is a generalized flow diagram illustrating another implementation of a method for changing power states and updating sensitivity data in a computing system.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for allocating power in a computing system are disclosed. A system management unit detects a condition indicating a change in power is required or possible. Such a change may be detecting an indication that a power change is either required, possible, or requested. A change in power required may be due to the computing system reaching a power limit or thermal threshold. In response to detecting this condition, the system management unit identifies currently executing tasks of the computing system and accesses power sensitivity data to determine which of a number of computing units (or power domains) to select for power reduction. Based at least in part on the data, a unit is identified that is determined to have a relatively low sensitivity (or a lower sensitivity than one or more other units) to power state changes under the current operating conditions. A relatively low sensitivity indicates that a change in power to the corresponding unit will not have as significant an impact on overall performance of the computing system than if another unit was selected. Power allocated for the selected unit is then decreased. As used herein, in various implementations the term “unit” refers to a circuit or circuitry. As an example, a system management unit may be a system management circuit or system management circuitry.

Alternatively, a change in power condition may indicate that additional power is available for allocation. In response to detecting this condition, the system management unit identifies currently executing tasks of the computing system and accesses sensitivity data to determine which of a number of computing units or power domains to select for power reduction. Based at least in part on the data, a unit is identified that is determined to have a relatively high sensitivity (or a higher sensitivity than one or more other units) to power state change under the current operating conditions. A relatively high sensitivity indicates that a change in power to the corresponding unit will have a greater impact on overall performance of the computing system than if another unit was selected. Power allocated for the selected unit is then increased. After making changes to power states of one or more units in the computing system, the actual performance of the computing system is compared to what was predicted by the sensitivity data. If the prediction differs or is otherwise deemed inaccurate, an update to the data is performed to cause the data to more closely reflect the actual result of the power state change(s).

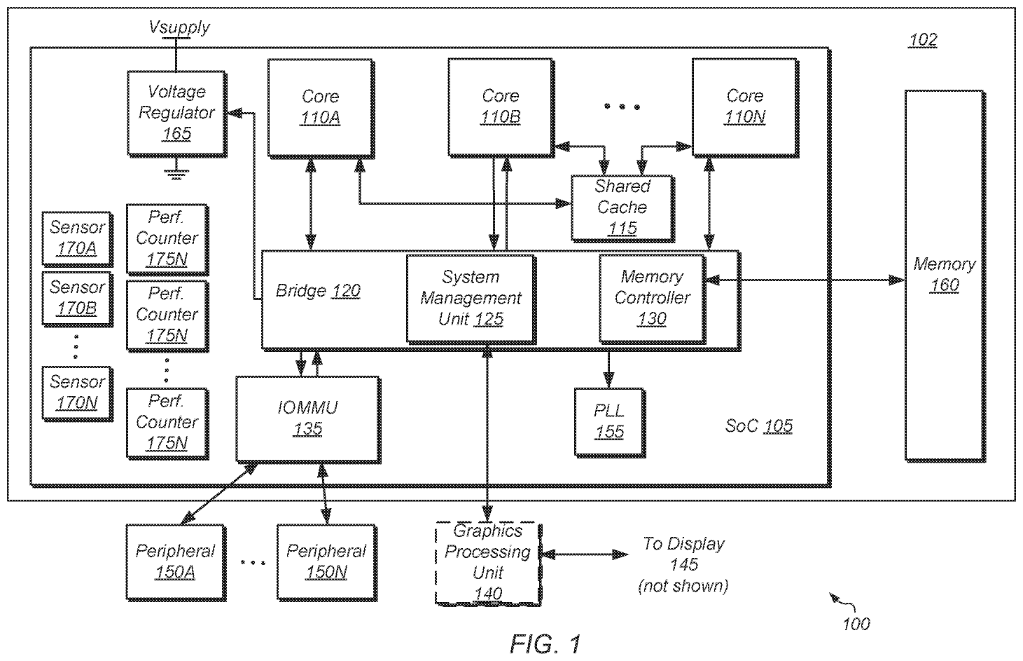

Referring now to FIG. 1, a block diagram of one implementation of a computing system 100 is shown. In this implementation, the illustrated computing system 100 includes system on chip (SoC) 105 coupled to memory 160. However, implementations in which one or more of the illustrated components of the SoC 105 are not integrated onto a single chip are possible and are contemplated. In some implementations, SoC 105 includes a plurality of processor cores 110A-N and GPU 140. In the illustrated implementation, the SoC 105, Memory 160, and other components (not shown) are part of a system board 102, and one or more of the peripherals 150A-150N and GPU 140 are discrete entities (e.g., daughter boards, etc.) that are coupled to the system board 102. In other implementations, GPU 140 and/or one or more of Peripherals 150 may be permanently mounted on board 102 or otherwise integrated into SoC 105. It is noted that processor cores 110A-N can also be referred to as processing units or processors. Processor cores 110A-N and GPU 140 are configured to execute instructions of one or more instruction set architectures (ISAs), which can include operating system instructions and user application instructions. These instructions include memory access instructions which can be translated and/or decoded into memory access requests or memory access operations targeting memory 160.

In another implementation, SoC 105 includes a single processor core 110. In multi-core implementations, processor cores 110 can be identical to each other (i.e., symmetrical multi-core), or one or more cores can be different from others (i.e., asymmetric multi-core). Each processor core 110 includes one or more execution units, cache memories, schedulers, branch prediction circuits, and so forth. Furthermore, each of processor cores 110 is configured to assert requests for access to memory 160, which functions as main memory for computing system 100. Such requests include read requests, and/or write requests, and are initially received from a respective processor core 110 by bridge 120. Each processor core 110 can also include a queue or buffer that holds in-flight instructions that have not yet completed execution. This queue can be referred to herein as an “instruction queue.” Some of the instructions in a processor core 110 can still be waiting for their operands to become available, while other instructions can be waiting for an available arithmetic logic unit (ALU). The instructions which are waiting on an available ALU can be referred to as pending ready instructions. In one implementation, each processor core 110 is configured to track the number of pending ready instructions.

Input/output memory management unit (IOMMU) 135 is coupled to bridge 120 in the implementation shown. In one implementation, bridge 120 functions as a northbridge device and IOMMU 135 functions as a southbridge device in computing system 100. In other implementations, bridge 120 can be a fabric, switch, bridge, any combination of these components, or another component. A number of different types of peripheral buses (e.g., peripheral component interconnect (PCI) bus, PCI-Extended (PCI-X), PCIE (PCI Express) bus, gigabit Ethernet (GBE) bus, universal serial bus (USB)) can be coupled to IOMMU 135. Various types of peripheral devices 150A-N can be coupled to some or all of the peripheral buses. Such peripheral devices 150A-N include (but are not limited to) keyboards, mice, printers, scanners, joysticks or other types of game controllers, media recording devices, external storage devices, network interface cards, and so forth. At least some of the peripheral devices 150A-N that are coupled to IOMMU 135 via a corresponding peripheral bus can assert memory access requests using direct memory access (DMA). These requests (which can include read and write requests) are conveyed to bridge 120 via IOMMU 135.

In some implementations, SoC 105 includes a graphics processing unit (GPU) 140 configured to be coupled to display 145 (not shown) of computing system 100. In some implementations, GPU 140 is an integrated circuit that is separate and distinct from SoC 105. GPU 140 performs various video processing functions and provides the processed information to display 145 for output as visual information. GPU 140 can also be configured to perform other types of tasks scheduled to GPU 140 by an application scheduler. GPU 140 includes a number ‘N’ of compute units for executing tasks of various applications or processes, with ‘N’ a positive integer. The ‘N’ compute units of GPU 140 may also be referred to as “processing units”. Each compute unit of GPU 140 is configured to assert requests for access to memory 160.

In one implementation, memory controller 130 is integrated into bridge 120. In other implementations, memory controller 130 is separate from bridge 120. Memory controller 130 receives memory requests conveyed from bridge 120. Data accessed from memory 160 responsive to a read request is conveyed by memory controller 130 to the requesting agent via bridge 120. Responsive to a write request, memory controller 130 receives both the request and the data to be written from the requesting agent via bridge 120. If multiple memory access requests are pending at a given time, memory controller 130 arbitrates between these requests. For example, memory controller 130 can give priority to critical requests while delaying non-critical requests when the power budget allocated to memory controller 130 restricts the total number of requests that can be performed to memory 160.

In some implementations, memory 160 includes a plurality of memory modules. Each of the memory modules includes one or more memory devices (e.g., memory chips) mounted thereon. In some implementations, memory 160 includes one or more memory devices mounted on a motherboard or other carrier upon which SoC 105 is also mounted. In some implementations, at least a portion of memory 160 is implemented on the die of SoC 105 itself. Implementations having a combination of the aforementioned implementations are also possible and contemplated. In one implementation, memory 160 is used to implement a random access memory (RAM) for use with SoC 105 during operation. The RAM implemented can be static RAM (SRAM) or dynamic RAM (DRAM). The type of DRAM that is used to implement memory 160 includes (but are not limited to) double data rate (DDR) DRAM, DDR2 DRAM, DDR3 DRAM, and so forth.

Although not explicitly shown in FIG. 1, SoC 105 can also include one or more cache memories that are internal to the processor cores 110. For example, each of the processor cores 110 can include an L1 data cache and an L1 instruction cache. In some implementations, SoC 105 includes a shared cache 115 that is shared by the processor cores 110. In some implementations, shared cache 115 is a level two (L2) cache. In some implementations, each of processor cores 110 has an L2 cache implemented therein, and thus shared cache 115 is a level three (L3) cache. Cache 115 can be part of a cache subsystem including a cache controller.

In one implementation, system management unit 125 is integrated into bridge 120. In other implementations, system management unit 125 can be separate from bridge 120 and/or system management unit 125 can be implemented as multiple, separate components in multiple locations of SoC 105. System management unit 125 is configured to manage the power states of the various processing units of SoC 105. System management unit 125 may also be referred to as a power management unit. In one implementation, system management unit 125 uses dynamic voltage and frequency scaling (DVFS) to change the frequency and/or voltage of a processing unit to limit the processing unit's power consumption to a chosen power allocation.

SoC 105 includes multiple temperature sensors 170A-N, which are representative of any number of temperature sensors. It should be understood that while sensors 170A-N are shown on the left-side of the block diagram of SoC 105, sensors 170A-N can be spread throughout the SoC 105 and/or can be located next to the major components of SoC 105 in the actual implementation of SoC 105. In one implementation, there is a sensor 170A-N for each core 110A-N, compute unit of GPU 140, and other major components. In this implementation, each sensor 170A-N tracks the temperature of a corresponding component. In another implementation, there is a sensor 170A-N for different geographical regions of SoC 105. In this implementation, sensors 170A-N are spread throughout SoC 105 and located so as to track the temperatures in different areas of SoC 105 to monitor whether there are any hot spots in SoC 105. In other implementations, other schemes for positioning the sensors 170A-N within SoC 105 are possible and are contemplated.

SoC 105 also includes multiple performance counters 175A-N, which are representative of any number and type of performance counters. It should be understood that while performance counters 175A-N are shown on the left-side of the block diagram of SoC 105, performance counters 175A-N can be spread throughout the SoC 105 and/or can be located within the major components of SoC 105 in the actual implementation of SoC 105. For example, in one implementation, each core 110A-N includes one or more performance counters 175A-N, memory controller 130 includes one or more performance counters 175A-N, GPU 140 includes one or more performance counters 175A-N, and other performance counters 175A-N are utilized to monitor the performance of other components. Performance counters 175A-N can track a variety of different performance metrics, including the instruction execution rate of cores 110A-N and GPU 140, consumed memory bandwidth, row buffer hit rate, cache hit rates of various caches (e.g., instruction cache, data cache), and/or other metrics.

In one implementation, SoC 105 includes a phase-locked loop (PLL) unit 155 coupled to receive a system clock signal. PLL unit 155 includes a number of PLLs configured to generate and distribute corresponding clock signals to each of processor cores 110 and to other components of SoC 105. In one implementation, the clock signals received by each of processor cores 110 are independent of one another. Furthermore, PLL unit 155 in this implementation is configured to individually control and alter the frequency of each of the clock signals provided to respective ones of processor cores 110 independently of one another. The frequency of the clock signal received by any given one of processor cores 110 can be increased or decreased in accordance with power states assigned by system management unit 125. The various frequencies at which clock signals are output from PLL unit 155 correspond to different operating points for each of processor cores 110. Accordingly, a change of operating point for a particular one of processor cores 110 is put into effect by changing the frequency of its respectively received clock signal.

An operating point for the purposes of this disclosure can be defined as a clock frequency, and can also include an operating voltage (e.g., supply voltage provided to a functional unit). Increasing an operating point for a given functional unit can be defined as increasing the frequency of a clock signal provided to that unit and can also include increasing its operating voltage. Similarly, decreasing an operating point for a given functional unit can be defined as decreasing the clock frequency, and can also include decreasing the operating voltage. Limiting an operating point can be defined as limiting the clock frequency and/or operating voltage to specified maximum values for particular set of conditions (but not necessarily maximum limits for all conditions). Thus, when an operating point is limited for a particular processing unit, it can operate at a clock frequency and operating voltage up to the specified values for a current set of conditions, but can also operate at clock frequency and operating voltage values that are less than the specified values.

In the case where changing the respective operating points of one or more processor cores 110 includes changing of one or more respective clock frequencies, system management unit 125 changes the state of digital signals provided to PLL unit 155. Responsive to the change in these signals, PLL unit 155 changes the clock frequency of the affected processing core(s) 110. Additionally, system management unit 125 can also cause PLL unit 155 to inhibit a respective clock signal from being provided to a corresponding one of processor cores 110.

In the implementation shown, SoC 105 also includes voltage regulator 165. In other implementations, voltage regulator 165 can be implemented separately from SoC 105. Voltage regulator 165 provides a supply voltage to each of processor cores 110 and to other components of SoC 105. In some implementations, voltage regulator 165 provides a supply voltage that is variable according to a particular operating point. In some implementations, each of processor cores 110 shares a voltage plane. Thus, each processing core 110 in such an implementation operates at the same voltage as the other ones of processor cores 110. In another implementation, voltage planes are not shared, and thus the supply voltage received by each processing core 110 is set and adjusted independently of the respective supply voltages received by other ones of processor cores 110. Thus, operating point adjustments that include adjustments of a supply voltage can be selectively applied to each processing core 110 independently of the others in implementations having non-shared voltage planes. In the case where changing the operating point includes changing an operating voltage for one or more processor cores 110, system management unit 125 changes the state of digital signals provided to voltage regulator 165. Responsive to the change in the signals, voltage regulator 165 adjusts the supply voltage provided to the affected ones of processor cores 110. In instances when power is to be removed from (i.e., gated) one of processor cores 110, system management unit 125 sets the state of corresponding ones of the signals to cause voltage regulator 165 to provide no power to the affected processing core 110.

In various implementations, computing system 100 can be a computer, laptop, mobile device, server, web server, cloud computing server, storage system, or any of various other types of computing systems or devices. It is noted that the number of components of computing system 100 and/or SoC 105 can vary from implementation to implementation. There can be more or fewer of each component/subcomponent than the number shown in FIG. 1. It is also noted that computing system 100 and/or SoC 105 can include other components not shown in FIG. 1. Additionally, in other implementations, computing system 100 and SoC 105 can be structured in other ways than shown in FIG. 1.

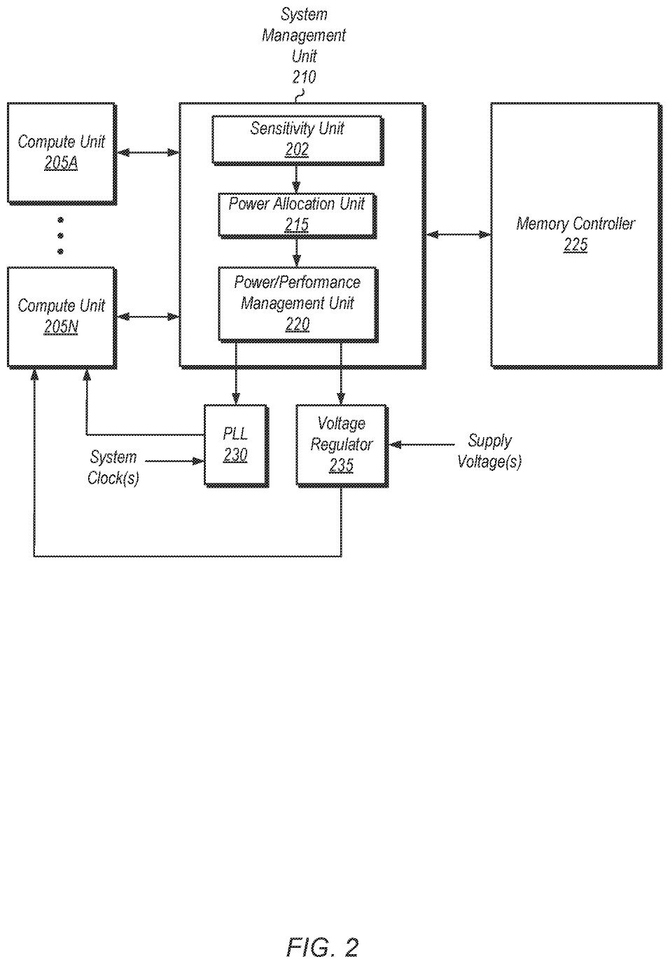

Turning now to FIG. 2, a block diagram of one implementation of a system management unit 210 is shown. System management unit 210 is coupled to compute units 205A-N, memory controller 225, phase-locked loop (PLL) unit 230, and voltage regulator 235. System management unit 210 can also be coupled to one or more other components not shown in FIG. 2. Compute units 205A-N are representative of any number and type of compute units (e.g., CPU, GPU, FPGA, etc.), and compute units 205A-N may also be referred to as processors or processing units. In some implementations, compute units include either or both of general purpose and special purpose computing circuitry. For example, in one implementation, at least one compute unit is a central processing unit (CPU) and another compute unit is a graphics processing unit (GPU).

System management unit 210 includes sensitivity unit 202, power allocation unit 215, and power management unit 220. Sensitivity unit 202 is configured to determine how sensitive performance of the system is to changes in power states based on the types of tasks being executed, the types of units executing tasks, current temperature, as well as others. Based on an identification of a unit that is less sensitive to power state changes than another unit, intelligent power budget allocation decisions can be made. For example, if a power limit has been reached and power must be reduced to some portion of the system, the sensitivity unit 202 determines which unit having its power reduced will have the least negative impact on system performance. Power allocation unit 215 is configured to allocate a power budget to each of compute units 205A-N, to a memory subsystem including memory controller 225, and/or to one or more other components. The total amount of power available to power allocation unit 215 to be dispersed to the components can be capped for the host system or apparatus. Power allocation unit 215 receives various inputs from compute units 205A-N including a status of the miss status holding registers (MSHRs) of compute units 205A-N, the instruction execution rates of compute units 205A-N, the number of pending ready-to-execute instructions in compute units 205A-N, the instruction and data cache hit rates of compute units 205A-N, the consumed memory bandwidth, and/or one or more other input signals. Power allocation unit 215 can utilize these inputs to determine whether compute units 205A-N have tasks to execute, and then power allocation unit 215 can adjust the power budget allocated to compute units 205A-N according to these determinations. Power allocation unit 215 can also receive inputs from memory controller 225, with these inputs including the consumed memory bandwidth, number of total requests in the pending request queue, number of critical requests in the pending request queue, number of non-critical requests in the pending request queue, and/or one or more other input signals. Power allocation unit 215 can utilize the status of these inputs to determine the power budget that is allocated to the memory subsystem.

PLL unit 230 receives system clock signal(s) and includes any number of PLLs configured to generate and distribute corresponding clock signals to each of compute units 205A-N and to other components. Power management unit 220 is configured to convey control signals to PLL unit 230 to control the clock frequencies supplied to compute units 205A-N and to other components. Voltage regulator 235 provides a supply voltage to each of compute units 205A-N and to other components. Power management unit 220 is configured to convey control signals to voltage regulator 235 to control the voltages supplied to compute units 205A-N and to other components. Memory controller 225 is configured to control the memory (not shown) of the host computing system or apparatus. For example, memory controller 225 issues read, write, erase, refresh, and various other commands to the memory.

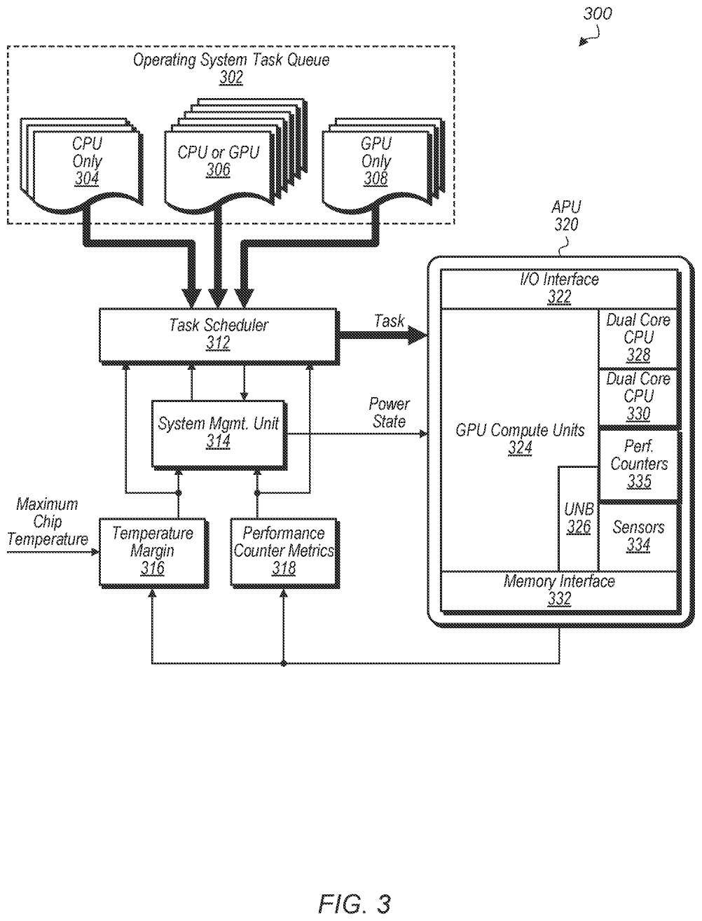

Turning now to FIG. 3, a block diagram of one implementation of a SoC 300 is illustrated. SoC 300 includes operating system task queue 302, task scheduler 312, system management unit 314, and accelerated processing unit (APU) 320. APU 320 includes input/output (I/O) interface 322, GPU compute units 324, unified north bridge (UNB) 326, dual core central processing unit (CPU) 328, dual core CPU 330, memory interface 332, and sensors 334. In other implementations, APU 320 includes other numbers of compute units, other numbers of CPUs, other components, and/or is organized in other suitable manners.

It is noted that sensors 334 are spread throughout APU 320 rather than located in one region of APU 320. For example, in one implementation, each compute unit of GPU 324 and each core of CPU 328 and 330 includes a sensor to monitor the temperature of each individual compute unit. Further, one or more units of the APU 320 include performance counters 335 to monitor various events, tasks, and conditions occurring during operation. Similar to sensors 334, performance counters 335 are spread throughout APU 320 rather than located in one region of APU 320. GPU compute units 324 include any number of compute units, depending on the implementation. The compute units of GPU 324 may also be referred to as cores. Dual core CPU 328 and dual core CPU 330 each include two cores. In other implementations, APU 320 includes other numbers of CPUs, and each CPU can have any number of cores.

Task scheduler 312 and system management unit 314 are implemented using any combination of software and/or hardware, depending on the implementation. In one implementation, task scheduler 312 and system management unit 314 are software components executing on dual-core CPUs 328 and 330 and/or GPU compute units 324. Task scheduler 312 works in combination with system management unit 314 to cooperatively perform task scheduling and power state decisions. Task scheduler 312 and system management unit 314 are configured to schedule tasks to the compute units and to control the power states of the compute units. Various pending tasks are stored in operating system task queue 302, and task scheduler 312 is configured to select tasks from task queue 302 for scheduling to the compute units.

Task scheduler 312 and system management unit 314 utilize various inputs for determining how to schedule tasks and manage power states. For example, task scheduler 312 and system management unit 314 use temperature margin 316 and performance counter metrics 318 as inputs to aid in determining how to schedule tasks and manage power states. Temperature margin 316 is the difference in the aggregate of measured temperatures from sensors on APU 320 from the maximum allowable chip temperature. For example, the maximum allowable chip temperature is 105 degrees Celsius in one implementation. Temperature margin 316 is monitored during operation of SoC 300 by task scheduler 312 and system management unit 314 to determine the margin for increasing the temperature of SoC 300. Performance counter metrics 318 represents data corresponding to performance counter 335 values in APU 320.

Queue 302 stores any number of tasks, and some tasks are targeted to CPUs only, GPUs only, or to either CPUs or GPUs. It is noted that the term “task” may also be used to refer to a “process” or “application” which is executed by one or more processing units of APU 320. In one implementation, queue 302 includes tasks 304 which are CPU-only tasks, tasks 306 which are CPU or GPU tasks, and tasks 308 which are GPU-only tasks. The classification of the different tasks indicates the preferred compute unit for executing the task. Task scheduler 312 utilizes the type of a given task when determining which compute unit to schedule the given task.

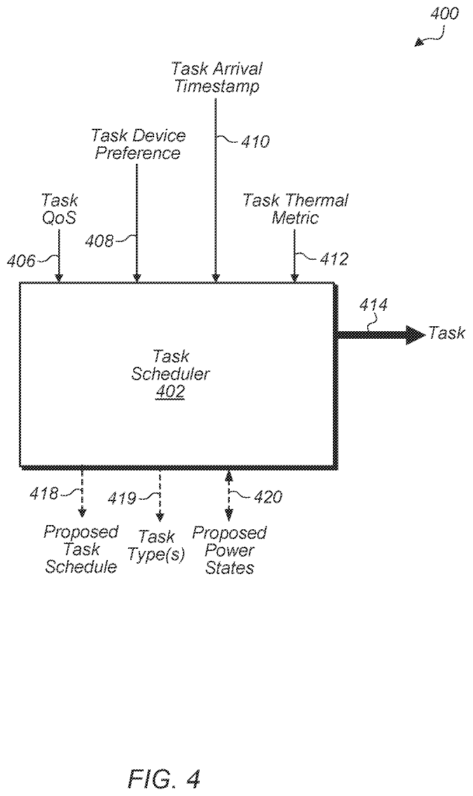

Referring now to FIG. 4, one implementation 400 of a task scheduler is shown. In one implementation, a task scheduler (e.g., task scheduler 412 of FIG. 4) assigns tasks from a task queue to a plurality of compute units of a SoC (e.g., SoC 400 of FIG. 4). The task scheduler 402 receives a plurality of inputs to use in determining how to schedule tasks to the various compute units of the SoC. The task scheduler 402 also coordinates system management unit (e.g., system management unit 314 of FIG. 3) to determine an optimal task schedule for the pending tasks to the compute units of the SoC. The plurality of inputs utilized by the task scheduler 402 includes the thermal metrics 412 (i.e., degree of hotness/coldness) of the tasks in terms of the amount of heat estimated to be generated, quality of service (QoS) 406 requirement of the queued tasks, task arrival timestamp 410, and respective device preferences 408 (e.g., CPU, GPU). In other implementations, the task scheduler utilizes other inputs to determine an optimal task schedule 418 for the pending tasks 414. In various implementations, information regarding proposed task schedules 418 and task types 419 is conveyed to, or otherwise make available to, system management unit 314.

In one implementation, the task scheduler 402 attempts to minimize execution time of the tasks on their assigned compute units and the wait time of the tasks such that the temperature increase of the compute units executing their assigned tasks stays below the temperature margin currently available. The task scheduler 402 also attempts to schedule tasks to keep the sum of the execution time of a given task plus the wait time of the given task less than or equal to the time indicated by the QoS setting of the given task. In other implementations, other examples of algorithms for a task scheduler are possible and are contemplated.

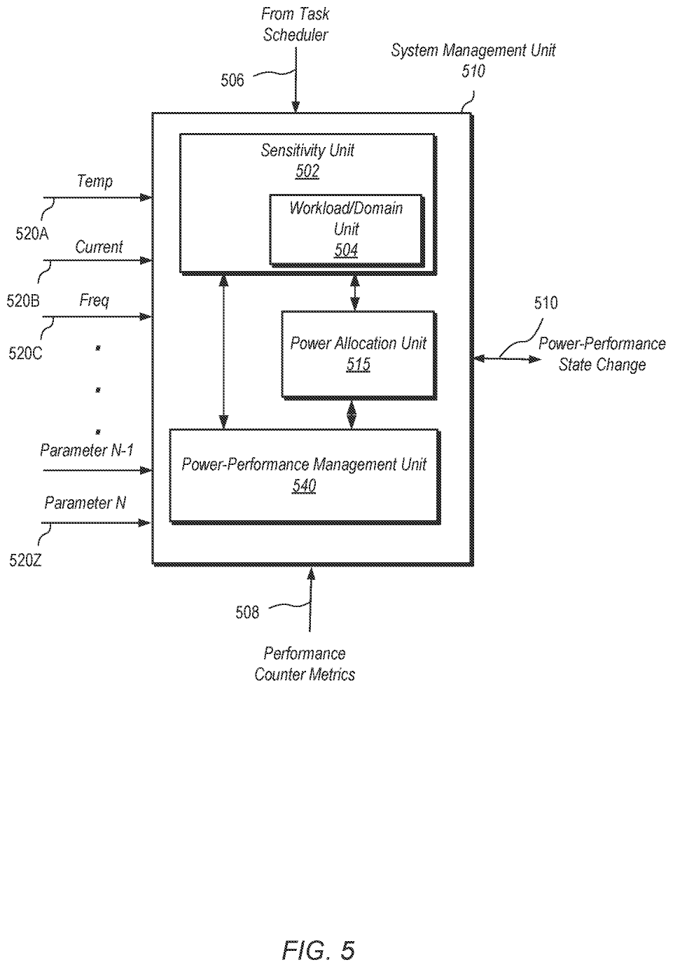

FIG. 5 illustrates a system management unit 510 that includes a sensitivity unit 502, power allocation unit 515, and power/performance management unit 540. System management unit 510 is also shown as being configured to receive any number of various system parameters, shown as 520A-520Z, that correspond to conditions, operations, or states of the system. In the example shown, the parameters are shown to include operating temperature 520A of a given unit(s), current drawn by given unit(s) 520B, and operating frequency of a given unit(s). Other parameters are possible and are contemplated. In various implementations, the one or more of the parameters 520 are reported from other units or parts of a system (e.g., based on sensors, performance counters, other event/activity detection, or otherwise). In some implementations, one or more parameters are tracked within the system management unit 510. For example, system management unit 510 may track current power-performance states of components within the system, duration(s) of power-performance state, previously reported parameters, and so on. In addition, system management unit 510 is configured to receive task related information 506 from the task scheduler (e.g., Task Scheduler 312 of FIG. 3). For example, as discussed in relation to FIG. 4, such information may include proposed task schedules, task types, and proposed power states.

In the example of FIG. 5, sensitivity unit 502 includes workload/domain unit 504. In one implementation, workload/domain unit 504 comprises data indicative of the sensitivity of various portions of the computing system to changes in power states. In other implementations, workload/domain unit 504 is configured to calculate such data. For example, in one implementation, workload/domain unit 504 includes characterization data generated by executing various workloads and evaluating performance in relation to power state changes. In some implementations, this data includes characterization data generated offline. In other implementations, the data includes characterization generated at runtime. In still further implementations, characterization data maintained by the workload/domain unit 504 is programmable and may be updated during runtime based on a comparison of predicted power/performance changes compared to actual power/performance changes. In one implementation, workload/domain unit 504 includes circuitry configured to perform calculations representative of relationships between task types, power state changes, and predicted performance changes. In other implementations, estimate unit 530 may include a combination of hardware and software (e.g., firmware) to calculate such relationships. Based on predictions made by the sensitivity unit 502, power budgets in the computing system are changed.

In some implementations, sensitivity unit 502 is configured to determine how power is allocated in the computing system. In one scenario, in response to detecting a particular condition, the sensitivity unit 502 determines a power budget allocation for various units within the computing system. In some implementations, system management unit 502 provides information to one or both of power allocation unit 515 and power-performance management unit 540 for use in making power allocation decisions. Various such implementations and combinations are possible and are contemplated.

In one scenario, the above-mentioned condition is a condition which requires a reduction in power consumption of the computing system (or some component(s) of the computing system). This condition may occur as a result of the system reaching a maximum allowed or allocated power. Alternatively, this condition may occur as a result of a thermal condition (e.g., a maximum operating temperature has been reached). In response to detecting the condition, sensitivity unit 502 evaluates a variety of parameters including one or more of the currently running task(s), types of tasks, phases of given tasks, and so on. In some implementations, the sensitivity unit receives performance counter metrics 508 that help identify the types of tasks, task phases, and activities occurring within the system. In some implementation, information related to executing tasks is received from task scheduler 506. Based on the information, the sensitivity unit 506 identifies one or more units of the computer system for power reduction. In this context, the sensitivity unit 506 identifies a given power domain of which the unit is a part. As used herein, a “power domain” refers to a portion of the system which shares a voltage and/or frequency. In order to determine which unit(s) will be allocated less power, the sensitivity unit 502 determines which such unit(s) will have the least negative impact on performance if its power is reduced.

Generally speaking, reducing power to unit will reduce performance of the unit. However, the impact on overall system performance can vary significantly depending on the current tasks being executed. For example, if currently executing tasks are transferring large amount of data to/from memory, then reducing power to the memory subsystem can have a significant negative impact on overall performance. Consequently, in such a scenario, the sensitivity unit 502 will seek to identify a different portion of the system for power reduction. For example, if the current tasks are memory intensive as noted above, and not compute intensive, then the sensitivity unit may identify a power domain that includes computation units for power reduction. In response, a power-performance state of the computation unit power domain is reduced and overall power consumption is reduced without significantly impacting system performance.

In an alternative scenario, in response to detecting a particular condition, the sensitivity unit 502 determines additional power is available for allocation. Such a condition may be, for example, power consumption is lower than a maximum allowed power. In such a scenario, the sensitivity unit 502 is configured to identify a unit(s) which will result in the largest performance increase if power is increased to the unit. In various implementations, the decision is based on (or at least in part on) the incremental benefit of increasing power to a given unit. For example, based on workload/domain unit 504 data, a performance/watt increase is determined for one or more units given the currently executing tasks, scheduled tasks, and/or other operating conditions. Performance metrics considered include any of a variety of metrics known to those skilled in the art. For example, during characterization, thousands of tests may be run to evaluate system power performance. Particular metrics regarding CPU performance, GPU performance, memory performance, and other system components, are gathered. Examples of performance metrics include instructions per second, floating point operations per second, memory bandwidth, frames per second, benchmark scores, 3DMark scores, as well as others. By comparing the tasks being (or to be) executed to the workload/domain unit 504 data, the system management unit 502 identifies which unit receiving a given amount of increased power would result in the greatest performance increase. Having identified the unit, power allocated for the unit is increased. In various implementation, this entails increasing the power-performance state of the identified unit.

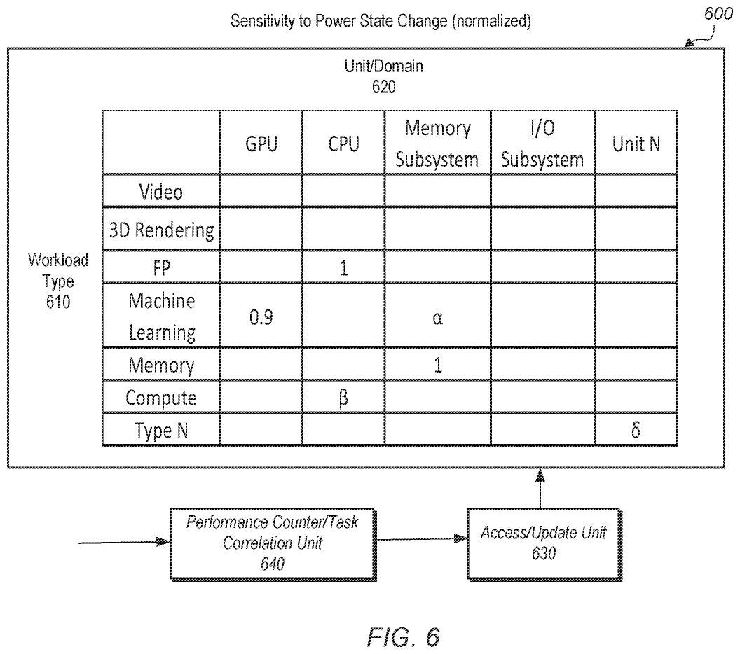

FIG. 6 illustrates one example of data maintained by (or accessible to) the workload/domain unit 504 that indicates a sensitivity to power state changes. In this example, a data structure 600 is shown that correlates workload types 610 to computing unit/domains 620. For purposes of discussion, sample values are shown in a few entries of the data structure for illustrative purposes. Other values are possible and are contemplated. Further, additional data may be maintained for each entry. Some values are shown as normalized values between 0.0-1.0. A sensitivity of 0.0 indicates no performance impact on the computing system as a result of changes to the given unit for the given task. For example, if all activity is currently transferring data from memory, then changing a power state of a computation unit in the GPU may not impact performance. A sensitivity of 1.0 indicates a very high level of sensitivity to power state changes of a given unit for a given task. Other sample entries are shown including different types of values (e.g., α, β, δ). Any of a variety of types of values may be calculated or maintained. For example, while normalized sensitivity values may be used as noted above. Other implementations may use a performance/watt metric or some other metric to indicate the relative change in performance that occurs in response to a change in power. Numerous such implementations are possible and are contemplated. For example, using the scenario, if data is being transferred from memory and a power state change is made to the memory subsystem, a significant performance impact will occur. It is noted that while the example shows the data structure 600 in the form of a table, other implementations are possible and are contemplated. As shown in the example, workload types 610 include video streaming, 3D rendering, floating point (FP), Neural Network (application related), memory, compute/computation, I/O, and other Types. Any number and type of workload can be characterized. The illustrated units/domains 620 include GPU, CPU, Memory subsystem, I/O subsystem, as well as other Unit types. Like workload types, any number and type of units can be characterized. Also shown is an access/update unit 630 for use in accessing and updating the data within the structure 600, and a performance counter/task correlation unit 640.

During characterization, many applications and tasks are executed on the computing system while monitoring performance of individual units, overall performance of the system, current being drawn, frequencies of operation, changes in performance with respect to changes in power, and so on. Additionally, performance counters within the system are tracked and monitored in order to correlate values of the performance counters with types of applications and tasks. In this manner, the given types of tasks and application are identifiable based on the values of the performance counters. For example, in such an implementation, data is maintained (e.g., within performance counter/task correlation unit 640) that correlates workload types with various performance counter values. This approach gives a level of insight into current task processing that might not otherwise be available. For example, while it may be known that a given task type has been scheduled for execution by the task scheduler 402, that task type may include a variety of phases of execution. For example, one phase may be a compute intensive phase, while another phase may be a memory intensive phase. By having access to the performance counter values, the particular phase of execution can be identified and accounted for when allocating power.

In one implementation, when a power state change condition is detected, performance counter/task correlation unit 640 is configured to identify at type of task(s) being executed based on performance counter values. Access/update unit 630 then uses the identified task(s) to access the data in the data structure 600. Based on the task(s) being executed, one or more units are identified as being more or less sensitive to power state changes. In a scenario in which a power reduction is required, then a unit that is least sensitive to a power state change is identified and selected for power reduction. In the event multiple units qualify (e.g., multiple units have an equally low sensitivity to power changes), then a decision as to the unit selected may be based on any of a number of other factors (e.g., upcoming tasks for execution, etc.). In this manner, power may be reduced without unduly impacting performance of the system. Conversely, when the scenario is one in which additional power is available for allocation, then a unit that is more highly sensitive to power state changes is identified and selected. In this manner, power may be increased in a manner that results in the greatest (of relatively higher sensitivity) performance increase than if another unit had been selected.

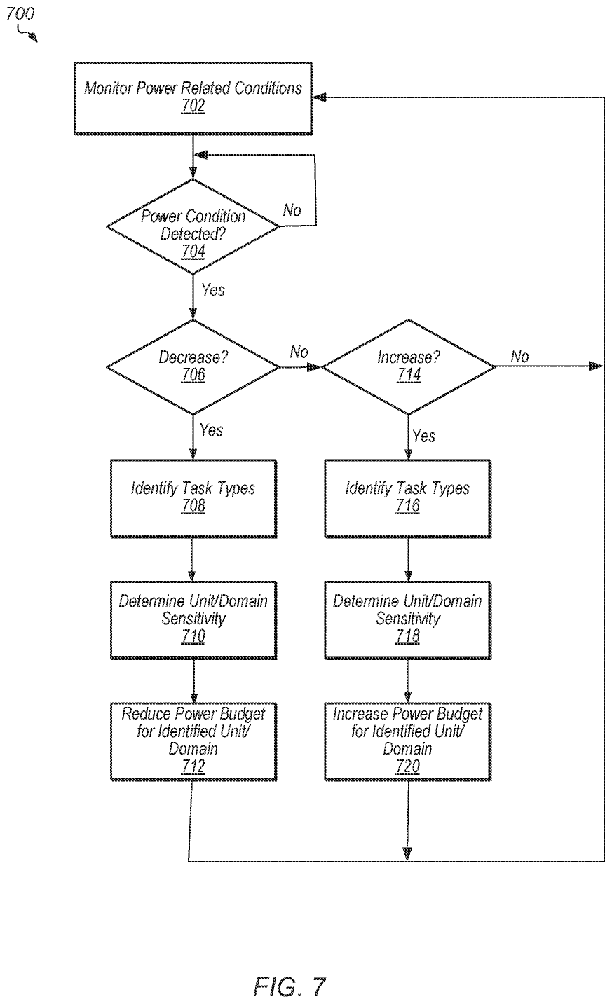

Turning now to FIG. 7, one implementation of a power state change based on sensitivity is shown. It is noted that while the method shown in FIG. 7 includes steps in a given order, in other implementations, the order may be different, some steps may be performed concurrently, some steps may be omitted, and others may be added. In this example, power related conditions are monitored (702) based on system parameters and conditions as discussed above (e.g., via sensors 170, performance counters 175, workloads, etc.). If a power condition is indicated or otherwise detected (704), a determination is made as to whether power is to be decreased (706) or increased (714). If it is determined that power is to be decreased (706), then currently executing task types are identified (708). As discussed above, these tasks may be identified based on performance counter information, information received from the task scheduler regarding past and upcoming tasks, and so on. Based on the identified tasks, unit/domain sensitivity is determined (710). For example, data that correlates workload, application, and task types to power change sensitivity is accessed in order to identify a unit/domain for power reduction. As a power decrease is required, in one implementation, a unit that is less sensitive to power changes given the current (or upcoming) tasks is identified for power reduction and the power to that unit is reduced (712). If a power reduction is required and no unit/domain is identified as having a different sensitivity to power changes than other units/domains given the current conditions (e.g., all units/domains have a same sensitivity), then a unit/domain may be selected for power reduction based on another basis. For example, a unit/domain could be chosen at random, according to a round-robin approach, based on a current temperature of a given unit/domain (e.g., reduce the power of the unit/domain that currently has the highest temperature), and so on. Numerous such alternatives are possible and are contemplated. In one implementation, reducing power to the identified unit is accomplished by reducing a power-performance state of the unit. In other implementation, a power budget allocated to the unit is reduced, and the power-performance state of the unit is reduced in response to the decrease in power budget.

If it is determined that a power increase is possible (714) (e.g., a request to increase performance and/or power), then task types are identified (716) as discussed above, and units/domains are identified that are relatively sensitive to power state changes. In other words, the method seeks to identify which units will increase overall system performance more (relative to other units) given an increase in power. Having identified such a unit/domain its power is increased (720). In this manner, power is used more efficiently. For example, if allocating 10 watts of additional power to unit A would result in an increase in system performance of 2% and allocating the 10 watts of additional power to unit B would result in an increase in system performance of 15%, the unit B is selected. In this case, the performance to power increase per watt of unit A is 2/10=0.2 and the performance to power increase per watt of unit B is 15/10=1.5. Accordingly, the power to performance per watt benefit of unit B is greater and unit B is selected.

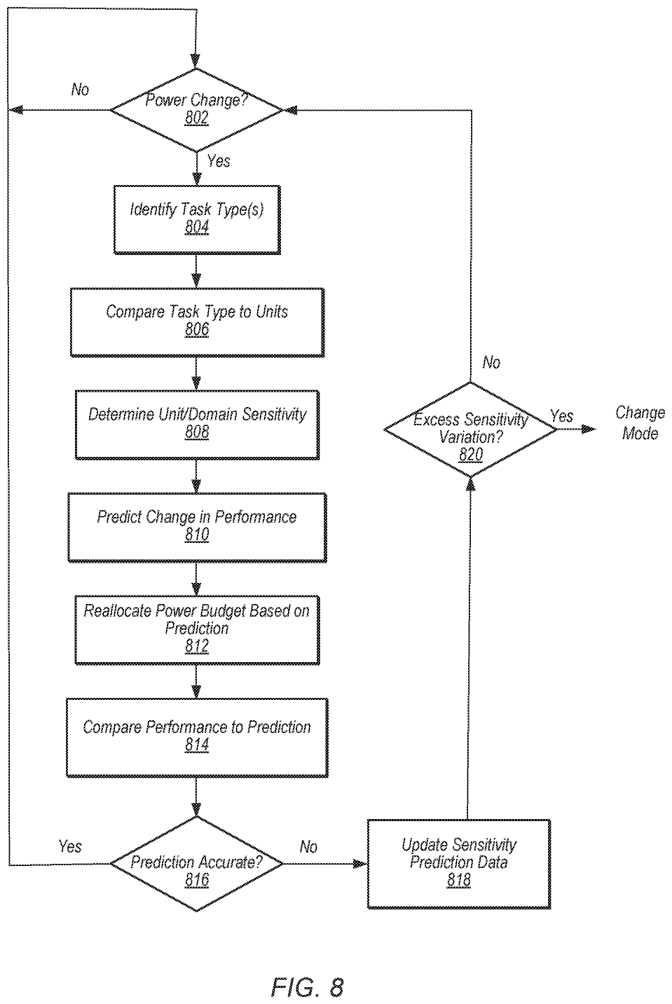

FIG. 8 illustrates an implementation in which data maintained by the workload/domain unit 504 can be dynamically updated. In this example, units are selected for power increases or decreases as discussed above based (at least in part) on the maintained data. However, in the event that the predicted outcome is not accurate, then an update to the data can be performed. For example, in FIG. 7 discussed above, unit B was selected due to the data indicating it was more sensitive to power changes. In particular, unit A was described as having a performance to power increase per watt of 0.2 while unit B had a performance to power increase per watt of 1.5 and unit B was selected. If after selecting unit B it is observed that the performance increase is 3% rather than 15%, then an update to the maintained data can be performed (e.g., by Access/Update Unit 630). In this manner, better selections of units for power changes can be made in the future.

If, in FIG. 8, a power change condition is detected (802), then task types (currently executing and/or upcoming) are identified (804). The identified task type(s) are then compared or cross-referenced with various types of units in the computing system (e.g., CPU, GPU, etc.) (806). Based on the comparison, unit/domain sensitivity of the various unit is determined in view of the identified tasks (808) and a predicted change is performance is made for each of the units (810). In one implementation, the predicted change in performance is based at least in part on the identified sensitivity of the unit(s) to power changes given the identified tasks. After identifying one or more units, power to the units is changed (812) by either increasing or decreasing depending on the scenario as discussed above. Subsequently, the resulting performance is compared to what was predicted (814). If the prediction is deemed accurate (816), then the method returns to block 802. If the prediction is not deemed accurate (816), then an update to the data is performed (818) to cause the maintained data to more closely reflect the actual result. Determining whether the prediction is accurate may entail determining if the prediction is within a threshold % or otherwise. In some implementations, this threshold and/or other conditions used to determine if a prediction is accurate are programmable. In addition to the above, in some implementations the sensitivity unit is configured to be enabled based on a mode (e.g., sensitivity metrics mode is enabled). For example, use of the methods and mechanisms described herein may be programmable for use by default or otherwise. In some implementations, if excess sensitivity variation of a workload is detected over time (block 820), then use of the sensitivity metrics may be deemed unreliable for that particular scenario and a change in mode is made that causes the sensitivity metric(s) to not be used (i.e., sensitivity metrics mode is disabled). In various implementations, excess sensitivity variation may be determined based at least in part on a number of inaccurate predictions, a prediction that is inaccurate by at least a threshold amount (e.g., actual performance increase was less than X % of the predicted performance increase), or any other suitable method. The cessation of the use of the sensitivity metrics can be for the duration of the workload, a fixed or programmable period of time, or otherwise. When not operating in sensitivity metrics mode, any other method or mechanism for throttling power can be used.

In various implementations, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a system management unit configured to:
in response to detection of a condition indicative of a change to a power-performance state of a computing system comprising a plurality of units:
select a given unit of the plurality of units, based at least in part on a power sensitivity of the given unit to changes in power; and
change a power-performance state of the given unit.

2. The system as recited in claim 1, wherein the given unit is selected based at least in part on a type of workload being executed or scheduled for execution by the computing system.

3. The system as recited in claim 2, wherein in response to the condition indicating a decrease in power:
the given unit is selected based at least in part on a determination that the given unit has a lower sensitivity to power changes than one or more other units of the plurality of units when the type of workload is being executed; and
a power-performance state of the given unit is decreased.

4. The system as recited in claim 2, wherein in response to the condition indicating an increase in power:
the given unit is selected based at least in part on a determination that the given unit has a higher sensitivity to power changes than one or more other units of the plurality of units when the type of workload is being executed; and
a power-performance state of the given unit is increased.

5. The system as recited in claim 2, wherein the type of workload being executed is determined based at least in part on performance counters in the computing system.

6. The system as recited in 1, further comprising sensitivity data that indicates a sensitivity of one or more of the plurality of units to changes in power when executing a given type of workload.

7. The system as recited in claim 6, wherein subsequent to changing a power-performance state of the given unit, the system management unit is configured to compare a predicted performance of the computing system to an actual performance of the computing system.

8. The system as recited in claim 7, wherein in response to determining the actual performance differs from the predicted performance, the system management unit is configured to update the sensitivity data.

9. A method comprising:
detecting a condition indicative of a change to a power-performance state of a computing system comprising a plurality of units; and
in response to the detection:
selecting a given unit of the plurality of units, based at least in part on a power sensitivity of the given unit to changes in power; and
changing a power-performance state of the given unit.

10. The method as recited in claim 9, further comprising selecting the given unit based at least in part on a type of workload being executed or scheduled for execution by the computing system.

11. The method as recited in claim 10, wherein in response to the condition indicating a decrease in power:
selecting the given unit based at least in part on determining that the given unit has a lower sensitivity to power changes than one or more other units of the plurality of units when the type of workload is being executed; and
decreasing a power-performance state of the given unit.

12. The method as recited in claim 11, wherein in response to the condition indicating an increase in power:
selecting the given unit based at least in part on determining that the given unit has a higher sensitivity to power changes than one or more other units of the plurality of units when the type of workload is being executed; and
increasing a power-performance state of the given unit.

13. The method as recited in claim 11, further comprising determining the type of workload being executed based at least in part on performance counters in the computing system.

14. The method as recited in 9, further comprising accessing sensitivity data that indicates a sensitivity of one or more of the plurality of units to changes in power when executing a given type of workload.

15. The method as recited in claim 14, wherein subsequent to changing a power-performance state of the given unit, the method comprises comparing a predicted performance of the computing system to an actual performance of the computing system.

16. The method as recited in claim 15, wherein in response to determining the actual performance differs from the predicted performance, the method comprises updating the sensitivity data.

17. A system comprising:
a memory subsystem;
one or more processors; and
a system management unit configured to:
in response to detection of a condition indicative of a change to a power-performance state of a computing system comprising a plurality of units:
select a given unit of the plurality of units, based at least in part on a power sensitivity of the given unit to changes in power; and
change a power-performance state of the given unit.

18. The system as recited in claim 17, wherein the given unit is selected based at least in part on a type of workload being executed or scheduled for execution by the computing system.

19. The system as recited in claim 18, wherein the given unit is one of a central processing unit, a graphics processing unit, and the memory subsystem.

20. The system as recited in 17, further comprising sensitivity data that indicates a sensitivity of one or more of the processors and memory subsystem to changes in power when executing a given type of workload
